(19) United States
(12) Patent Application Publication
(10) Pub. No.: US 2014/0351384 A1
(43) Pub. Date: Nov. 27, 2014

(54) INTERNET MULTIMEDIA PLAYBOOK SYSTEM AND METHOD THEREOF

(71) Applicant: Ovomedia Creative Inc., Zhubei City (TW)

(72) Inventor: Yu Shun WU, Zhubei City (TW)

(73) Assignee: Ovomedia Creative Inc., Zhubei City (TW)

(21) Appl. No.: 13/957,948

(22) Filed: Aug. 2, 2013

(30) Foreign Application Priority Data
May 24, 2013 (TW) 102118506

(51) Int. Cl. H04L 29/06

(52) U.S. Cl. CPC H04L 65/4069
USPC 709/219

(57) ABSTRACT

An internet multimedia playback system and a method thereof are provided. The internet multimedia playback system includes a multimedia server, a playlist server, an internet device and an internet multimedia playback device. The multimedia server is for storing a plurality of video streams. The playlist server is for storing playlists according to different accounts. The internet device links the multimedia server and the playlist server, wherein a user can link the playlist server with a specific account thereof, and then add the internet address about the video stream that the user wants to watch, to the playlist server with the playlist form. When the internet multimedia playback device is turned on, the internet multimedia playback device links the playlist server with the specific account to acquire the playlist corresponding to the specific account, and then links to the multimedia server according to the internet address in the playlist to sequentially play the videos in the playlist.

This application claims priority of No. 102118506 filed in Taiwan R.O.C. on May 24, 2013 under 35 USC 119, the entire content of which is hereby incorporated by reference.

### BACKGROUND OF THE INVENTION

1. Field of Invention

The present invention relates to the technology of multimedia playback, and more particularly to an internet multimedia playback system and a method thereof.

2. Related Art

With the progress of the technology, the electronic technology has been developed from the earliest vacuum tubes and transistors to the integrated circuit chips, which have been widely used. Thus, electronic products have gradually become indispensable necessities in the daily life of the modern human beings. Because of the popularization of the internet, more and more people would watch multimedia video streams from the internet, such as Youtube. However, general office workers are not allowed to watch Internet multimedia video at work. Thus, many people would use the lunch break to watch Internet multimedia video from their mobile phones. But, the lunch break is short, and user may be forced to stop watching in half way of the playback of the video due to the end of the lunch break. Generally, users may make a memo to resume the video after coming home. However, it is easy to forget for many people.

### SUMMARY OF THE INVENTION

It is therefore an objective of the present invention to provide an internet multimedia playback system and a method thereof, wherein a user can use a simple operation to record the address of the internet multimedia file(s) he/she wants. Also, when the user comes home, and turns the multimedia playback device on, the multimedia playback device automatically plays the recorded multimedia file(s).

To achieve the above-identified or other objectives, the present invention provides an internet multimedia playback system. The internet multimedia playback system comprises a multimedia server, a playlist server, an internet device and a first internet multimedia playback device. The multimedia server is coupled to an internet for storing a plurality of multimedia video stream files. The playlist server is coupled to the internet for storing playlists according to different accounts. The internet device is coupled to the internet, wherein the internet device is coupled to the multimedia server and the playlist server through an application software, wherein a user can uses the internet device with the application software to connect to the playlist server through the internet with a specific account, and stores an internet address of a multimedia video stream, which the user wants to watch, to a playlist of the specific account. The first internet multimedia playback device has a power switch and a wireless internet module, wherein, when the power of the first internet multimedia playback device is turned on, the first internet multimedia playback device connects to the playlist server through the internet with the specific account to acquire the playlist of the specific account, and the first internet multimedia playback device connects to the multimedia server by the internet address of the multimedia video stream stored in the playlist through the internet to perform a multimedia playback. The above-mentioned internet includes but not limits Ethernet, WiFi, 3G, 4G and etc.

The present invention provides an internet multimedia playback method. The internet multimedia playback method comprise the steps of: internet-connecting to a playlist server with a specific account; acquiring a playlist corresponding to the specific account; internet-connecting to a multimedia server through an internet address in the playlist of the specific account; and sequentially converting an acquired multimedia video stream from the internet address of the playlist into a video output signal and playing through a multimedia playback device.

The spirit of the present invention is to update and add video streams in the playlist through logging in the playlist server with the user's private account by an internet device. After going home, as long as the user turns on the internet multimedia playback device provided in the present invention, the internet multimedia playback device can sequentially play the video streams of the playlist in the playlist server.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic depicting an internet multimedia playback system according to a preferred embodiment of the present invention.

FIG. 2 is a schematic depicting shape of the internet multimedia playback device 104 or 105 according to a preferred embodiment of the present invention.

FIG. 3 is a flow chart depicting an internet multimedia playback method according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

### The first Embodiment

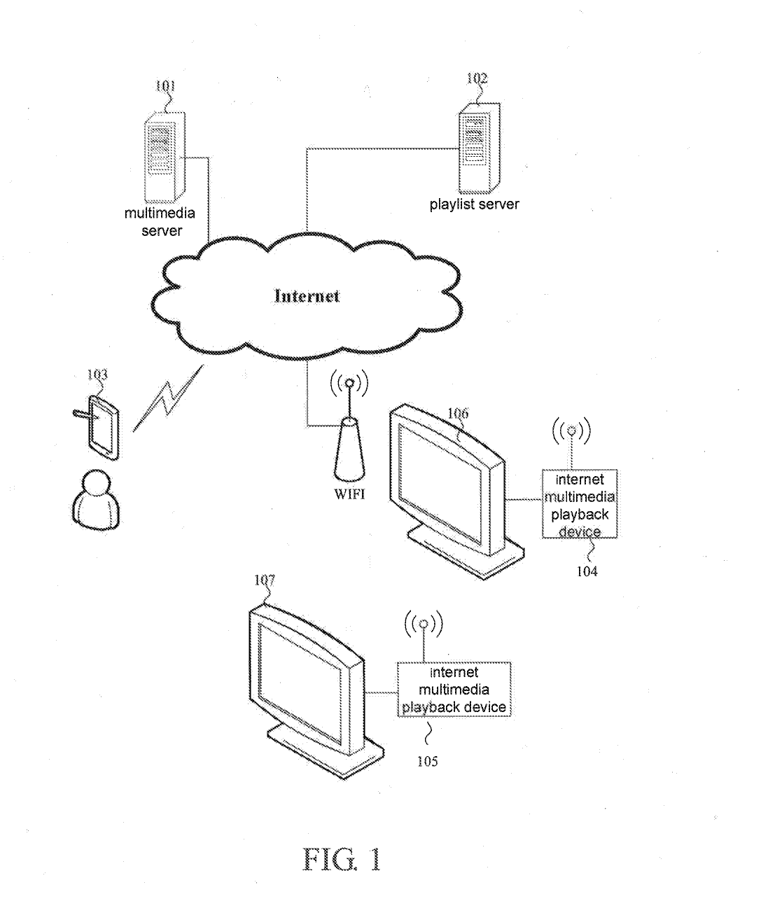

FIG. 1 is a schematic depicting an internet multimedia playback system according to a preferred embodiment of the present invention. Referring to FIG. 1, the internet multimedia playback system includes a multimedia server 101, a playlist server 102, an internet device 103, a first internet multimedia playback device 104, a second internet multimedia playback device 105, televisions 106 and 107. In this preferred embodiment, the internet device 103 is for example a smart phone. However, people having ordinary skill in the art should understand that the internet device represents an apparatus with Internet-capable function so that it also can be a laptop computer, personal computer, a tablet computer etc. Therefore, the present invention is not limited thereto.

Before a user starts to use the system, an application software is installed to the smart phone 103 by the user. The application software comprises web software having a browser web form. The application software is mainly used for applying for an account by the user and logging in the playlist server 102 by the applied account. Moreover, the user can find popular video stream or search a video stream interesting the user by keying a keywords. When the user fined the video stream interesting the user, the user has options of: 1. directly watching the video stream; and 2. adding the video stream into the playlist.

When the user decides to add video stream to the playlist, the application software stores the internet address of the above-mentioned video stream in the playlist server 102 and records the internet address of the video stream to the playlist corresponding to the account of the user. Moreover, the user may watch the front part of the video stream and then decide to add video stream to the playlist. Hence, the application software saves the internet address of the video stream to the playlist in the playlist server 102 corresponding to the user's account and the playback time information, which the video stream had been interrupted, would be also saved to the corresponding playlist.

The user can sequentially save a series of internet address corresponding to the video streams interesting the user into the playlist server 102. After the user comes off duty and goes home, he/she can directly turn on the first internet multimedia playback device 104. Then, the first internet multimedia playback device 104 wirelessly connects to the internet to acquire the playlist (including the interrupt playback time) through the user's account, and then the video stream is automatically converted to video signal, such as HDMI, to play on the television 106.

It is assumed that the first internet multimedia playback device 104 and the television 106 are disposed in a living room and the second internet multimedia playback device 105 and the television 107 are disposed in a bedroom. When the user leaves the living room and enters the bedroom and then the user wants to watch the video stream from the interrupted time point, the user can just turn off the power of the first internet multimedia playback device 104 before his/her leaving. Since the first internet multimedia playback device 104 is already connected to the playlist server 102 and the time information which the video stream has been play is also synchronously updated to the playlist server 102 through the internet during playing the video stream, the playback time information has been stored in the playlist server 102 before the power of the first internet multimedia playback device 104 is turned off. After the user enters the bedroom and turns on the second internet multimedia playback device 105, and then the user can watch the video stream from the interrupted time of the video stream according to the playback time information of the video stream stored in the playlist server 102.

Similarly, the user also can use the smart phone to perform fast forwarding, fast reversing, play, pause, operations and so on, to the above-mentioned video stream through the application software. Since the playback time information, which the video stream has been played, is synchronously updated to the playlist server 102 by the application software, the smart phone on the user's hand can be served as a remote controller for the first and second internet multimedia playback device 104 or 105.

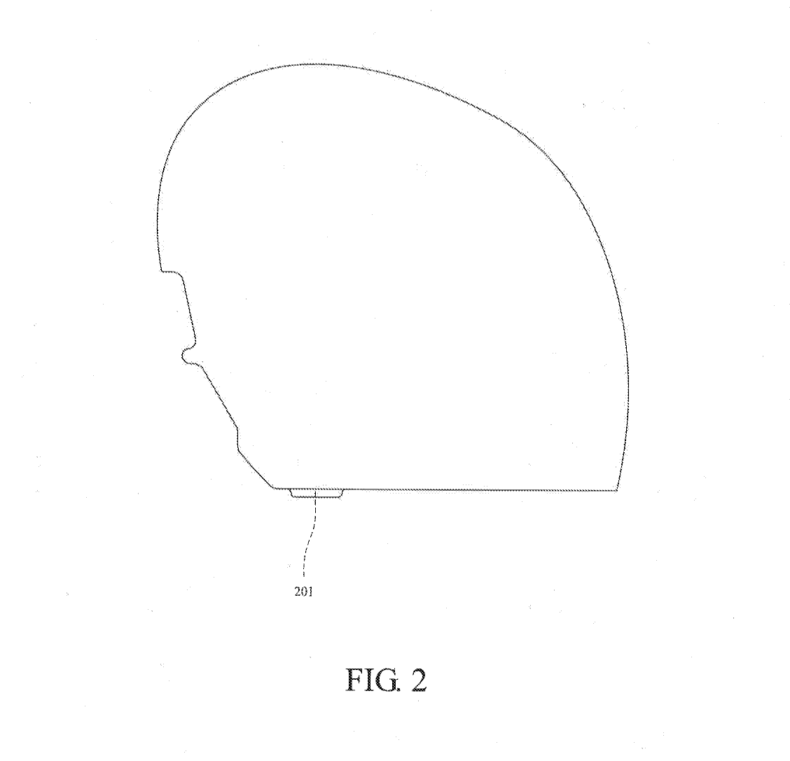

Next, FIG. 2 is a schematic depicting shape of the internet multimedia playback device 104 or 105 according to a preferred embodiment of the present invention. Referring to FIG. 2, it is observed that the appearance of the internet multimedia playback device 104 or 105 is an egg-shaped, and a power switch is disposed on the bottom. The appearance of the conventional wireless internet media players are shaped of square box with dull appearance and it is no longer attractive for the younger generation with the innovative ideas. The internet multimedia playback devices 104 and 105 of the present invention are design with high performance, low cost and stylish appearance and can meet market demand. In particular, due to the shape of egg, it is smooth with toughing. And, the power switch is designed at the bottom. As long as the user presses the body of the internet multimedia playback device 104 or 105, the power of the internet multimedia playback device 104 or 105 would be conveniently turned on or off. Moreover, although HDMI is taken as the embodiment to serve as the interface between the television and the internet multimedia playback device, people having ordinary skill in the art should understand that HDMI is one of multimedia transmission interfaces so that it also can be replaced by other interface, such as composite video interface, S-video interface, component video interface, DVI and so on. Therefore, the present invention is not limited thereto.

Further, the concept thereof is not only applied to the television and the internet multimedia playback device 104 or 105, but also applied to a device combining television with the internet multimedia playback device 104 or 105. For example, hardware of the internet multimedia playback device 104 or 105 is built-in to the TV, and the TV would become the internet multimedia playback device 104 or 105. In addition, as the advance of technology and the innovation, nowadays, TV may includes a built-in operation system (OS). Meanwhile, user may install the abovementioned application software to the OS of TV. Thus the TV can be served as the internet multimedia playback device 104 or 105 of the embodiment of the present invention. Therefore, the implementation form of the internet multimedia playback device 104 or 105 of the present invention is not limit thereto.

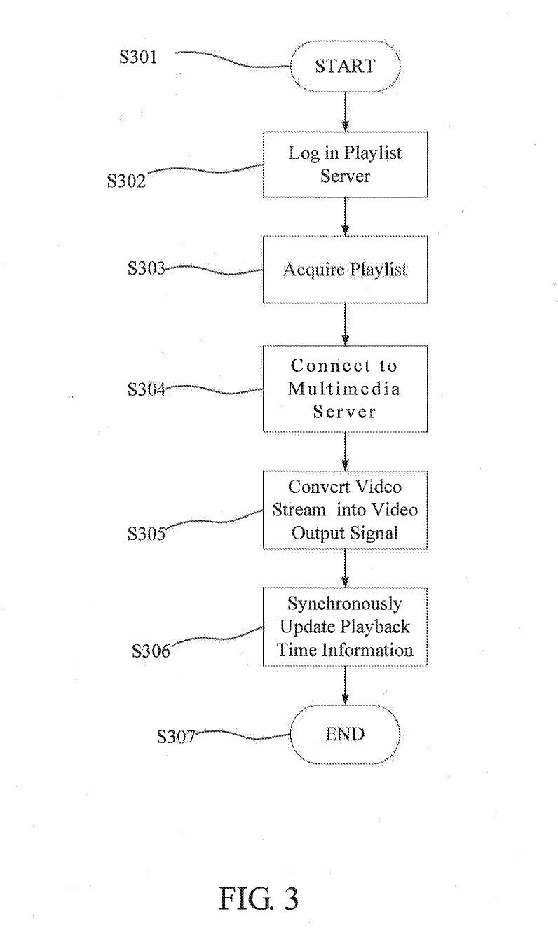

According to the above-mentioned embodiment, it is summarized an internet multimedia playback method. FIG. 3 is a flow chart depicting an internet multimedia playback method according to a preferred embodiment of the present invention. Referring to FIG. 3, the method includes the following steps.

In step S301, the internet multimedia playback method starts.

In step S302, logging in the server, wherein a user logs in the playlist server from the internet with a specific account.

In step S303, the playlist is acquired corresponding to the specific account.

In step S304, the multimedia server is connected according to the internet address(es) in the playlist of the specific account.

In step S305, sequentially converting the acquired multimedia video stream(s) from the internet address(es) to the video output signal, and playing the video output signal.

In step S306, updating the playback time information of the internet address of the multimedia video stream through the internet. Therefore, when the user operates one of the multimedia video streams in the playlist through an application software, the result of the operation thereof will be synchronously outputted to change the video output signal. Further, since the step performs the synchronous updating, even the user turns off one of the internet multimedia playback device of the present invention, and then the user turns on the other internet multimedia playback device or the original internet multimedia playback device, the played video stream can be resumed from the interrupted time.

In step S307, the internet multimedia playback method ends.

In summary, the spirit of the present invention is to update and add video streams to the playlist through logging in the playlist server by an internet device. After the user go home, as long as the user turns on the internet multimedia playback device of the present invention, the internet multimedia playback device can sequentially play the video streams of the playlist in the playlist server. Further, if the user has two or more than two internet multimedia playback devices, he/she can turn off the first internet multimedia playback device and turn on the second internet multimedia playback device, the second internet multimedia playback device can resume to play the video stream from the interrupted time point.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An internet multimedia playback system, comprising:
a multimedia server, coupled to an internet, for storing a plurality of multimedia video stream files;
a playlist server, coupled to the internet, for storing playlists according to different accounts;
an internet device, coupled to the internet, wherein the internet device is coupled to the multimedia server and the playlist server through an application software, wherein a user can uses the internet device with the application software to connect to the playlist server through the internet with a specific account, and stores an internet address of a multimedia video stream, which the user want to watch, to a playlist of the specific account; and
a first internet multimedia playback device, having a power switch and a wireless internet module, wherein, when the power of the first internet multimedia playback device is turned on, the first internet multimedia playback device connects to the playlist server through the internet with the specific account to acquire the playlist of the specific account, and the first internet multimedia playback device connects to the multimedia server by the internet address of a multimedia video stream stored in the playlist through the internet to perform a multimedia playback.

2. The internet multimedia playback system according to claim 1, wherein, when the first internet multimedia playback device plays the multimedia video stream, the first internet multimedia playback device synchronously updates a playback time information of the internet address of the multimedia video stream through the internet.

3. The internet multimedia playback system according to claim 2, further comprising:
a second internet multimedia playback device, having a power switch and a wireless internet module,
wherein, when the power of the first internet multimedia playback device is turned off, afterward, the power of the second internet multimedia playback device is turned on, the second internet multimedia playback device connects to the playlist server through the internet with the specific account to acquire the playlist of the specific account and playback time information, and resumes the previous multimedia video stream played by the first internet multimedia playback device according to the playlist of the specific account and playback time information.

4. The internet multimedia playback system according to claim 1, wherein the internet device comprises a mobile phone, a laptop computer, a personal computer, a tablet computer.

5. The internet multimedia playback system according to claim 1, wherein an appearance of the first internet multimedia playback device is a egg-shaped, having a HDMI output port, and also, a base of the first internet multimedia playback device is a plane, wherein the power switch of the first internet multimedia playback device is disposed on the base of the first internet multimedia playback device, wherein user can press the first internet multimedia playback device to turn on/off the first internet multimedia playback device.

6. The internet multimedia playback system according to claim 1, wherein, when the user performs an operation to one of multimedia video stream in the playlist of the specific account through the application software by the internet device, and the first internet multimedia playback device is turned on, an operation result thereof is outputted from the first internet multimedia playback device.

7. The internet multimedia playback system according to claim 1, wherein the first internet multimedia playback device comprises a HDMI port, wherein the first internet multimedia playback device is used for converting a received multimedia video stream into a HDMI video/audio signal to transmit to a display having HDMI interface.

8. An internet multimedia playback method, comprising:
internet-connecting to a playlist server with a specific account;
acquiring a playlist corresponding to the specific account;
internet-connecting to a multimedia server through an internet address in the playlist of the specific account; and
sequentially converting an acquired multimedia video stream from the internet address of the playlist into a video output signal and playing through a multimedia playback device.

9. The internet multimedia playback method according to claim 8, further comprising:
synchronously updating a playback time information of the internet address of the multimedia video stream in the playlist of the specific account when the multimedia video stream is played.

10. The internet multimedia playback method according to claim 8, wherein, when a user performs an operation to one of multimedia video streams in the playlist of the specific account through the application software by the internet device, an operation result thereof is outputted from the multimedia playback device:
